(19) United States
(12) Patent Application Publication
(10) Pub. No.: US 2002/0133753 A1
(43) Pub. Date: Sep. 19, 2002

(54) Component/Web services Tracking

(76) Inventors: Thomas Mayberry, Holliston, MA (US); Kevin Putnam, Waltham, MA (US)

Correspondence Address: DALY, CROWLEY & MOFFORD, LLP, SUITE 101, 275 TURNPIKE STREET, CANTON, MA, 02021-2310, US

(21) Appl. No.: 10/099,353

(22) Filed: Mar. 14, 2002

Related U.S. Application Data
(60) Provisional application No. 60/277,073, filed on Mar. 19, 2001.

(51) Int. Cl. G06F 11/30

(52) U.S. Cl. 714/38

(57) ABSTRACT

The present invention provides a methodology for obtaining and recording state information after execution of a method during testing of a software component. A GET method is executed after every method call and the returned values are compared against expected values. In such a manner the diagnosis of a failure of a method of a software component is greatly improved.

### CROSS REFERENCE TO RELATED APPLICATIONS

This application claims priority under 35 U.S.C. §119(e) to provisional patent application serial number 60/277,073 filed Mar. 19, 2001; the disclosure of which is incorporated by reference herein.

### BACKGROUND OF THE INVENTION

Componentized software is software that is designed to allow different pieces of the application, known as “software components” or “objects”, to be created separately but still to have the objects work together. The objects have standard interfaces that are understood and accessed by other objects. Some parts of these interfaces are enforced by the software language. If the interfaces are not used, the software objects will not be able to work with other objects.

An example of a software component is an Enterprise Java Bean™ software component (EJB). EJBs are written in the JAVA language, which is intended to be “platform independent.” Platform independent means that an application is intended to perform the same regardless of the hardware and operating system on which it is operating. Platform independence is achieved through the use of a “container.” A container is software that is designed for a specific platform. It provides a standardized environment that ensures the application written in the platform independent language operates correctly. The container is usually commercially available software and the application developer will buy the container rather than create it.

Typically, applications comprising combinations of software components have been tested in one of two manners. In the first manner, the objects are tested as they are written. Each object is tested to ensure that it performs the intended function. In the second manner, the objects are assembled into a completed application and the entire application is then usually tested. Heretofore, application testing has generally been done by applying test inputs at the client end and observing the response of the application.

Other tools are available to automate the execution of tests on applications. For example, Empirix Inc. of Waltham, Mass. provides a product called e-Load™. This tool simulates load on an application under test and provides information about the performance of the application. Another tool known as Bean-test™ also available from Empirix Inc. of Waltham, Mass. tests individual software components.

Automatic test generation tools, such as TestMaster™ available from Empirix Inc. of Waltham, Mass., are also available. Tools of this type provide a means to reduce the manual effort of generating a test. TestMaster™ works from a state model of the application under test. Such an application is very useful for generating functional tests during the development of an application. Once the model of the application is specified, TestMaster™ can be instructed to generate a suite of tests that can be tailored for a particular task—such as to fully exercise some portion of the application that has been changed. Model based testing is particularly useful for functional testing of large applications, but is not fully automatic because it requires the creation of a state model of the application being tested. While all of the above-described tools have proved to be useful for testing software components and applications which include software components, they are not able to test Web Services.

A Web Service is programmable application logic which is accessible using standard Internet protocols such as Hypertext Transfer Protocol (HTTP). Web services represent black-box functionality that can be reused without worrying how the service is implemented. Web services use a standard data format such as Extensible Markup Language (XML). A Web Service interface is defined in terms of the messages the Web Service accepts and produces. Users of the Web Service can be utilizing any platform in any programming language as long as they can create and consume the messages defined for the Web Service interface.

While software components can be tested by commercial software as described above, the testing of Web Services is more difficult. Similar to software components, Web Services provide functionality that can be used multiple times and by multiple different applications running on multiple different systems. Web services are accessed via web protocols such as Hypertext Transfer Protocol (HTTP) and by data formats such as Extensible Markup Language (XML). A Web Service interface is defined in terms of messages the Web Service can accept and generate. Users of the Web Service can be implemented on any platform and in any programming language, as long as they can create and consume the messages defined for the particular Web Service being utilized.

A protocol has been defined for performing information interchange with Web Services. This protocol is the Simple Object Access Protocol (SOAP). Typically objects are platform dependent, thus an object created on one platform cannot be used by software running on other platforms. Some distributed object technologies require the use of specific ports to transmit their data across the Internet (for example, DCOM uses port 135). Most firewalls prevent the use of all ports except for port 80, which is the default port for HTTP communications.

SOAP provides a platform independent way to access and utilize Web Services located on different distributed systems, and allows communications through firewalls. SOAP utilizes XML, and XML documents are transported via HTTP through firewalls.

SOAP messages are sent in a request/response manner. SOAP defines an XML structure to call a Web Service and to pass parameters to the Web Service. SOAP further defines an XML structure to return values that were requested from the Web Service. SOAP further defines an XML structure for returning error values if the Web Service cannot execute the desired function.

A system has an application residing thereon. Part of the application requires use of a particular Web Service which may be located on a remote machine. The application composes a SOAP message and sends the message to the server. The message travels across a network such as the Internet, and is received by the remote server which has the requested Web Service residing thereon. Once the SOAP message has been received by the server, the Web Service is called. Once the Web Service has finished processing, a SOAP message is prepared to be sent back to the application. The message is sent across the Internet to the system where it is processed by the application. In such a manner the Web Service is utilized by an application on a system remotely located from the Web Service. As described above SOAP allows systems to be highly distributed. Accordingly, developers are able to rely on the expertise and existing proven code of other developers to more quickly build more reliable systems.

For purposes of this description, the term software component will be used to include software components such as Enterprise Java Beans™ (EJBs), Component Object Model (COM) components, Distributed Component Object Model (DCOM) components, COM+ components, Common Object Request Broker Architecture (CORBA) as well as web services such as the .net web service.

A software component is tested by making sequences of calls to the methods of the component. As these methods are executed, the method returns results via its return value or its output parameters. These resulting values are validated against a set of criteria and any failures are reported to the user. This is an effective way of validating the quality of the component both in terms of its functionality and in terms of its ability to handle a load.

A problem associated with this methodology arises in diagnosing a software component that contains a failure. This is because the actual failure may not have anything to do with the called method that returned the incorrect result. For example, assume the following sequence of method calls made to a component that performs arithmetic operations: add ( ), subtract ( ), multiply ( ), divide ( ), multiply ( ), subtract ( ), multiply ( ), getResult ( ). If the add ( ) method failed to add correctly then the getResult ( ) method would return the wrong value. Determining that the problem was with the add ( ) method and not one of the other methods presents a significant challenge to the user.

In view of the foregoing it would be desirable to provide a methodology by which methods of the software component are tracked such that the results of method calls are immediately available.

### SUMMARY OF THE INVENTION

With the foregoing background in mind, it is an object of the present invention to record state information after execution of a method during testing of a software component. A GET method is executed after every method call and the returned values are compared against expected values. In such a manner the diagnosis of a failure of a method of a software component is greatly improved.

### BRIEF DESCRIPTION OF THE DRAWINGS

The invention will be better understood by reference to the following more detailed description and accompanying drawings in which:

FIG. 1 is a flow chart of the presently disclosed method.

### DETAILED DESCRIPTION

Most software components contain state information that may be viewed through properties or “Get” methods of the interfaces of the component. This provides the ability to “peer” into the component in order to examine the state of the component. The present invention takes advantage of this access in order to capture and validate the internal state of the component after the execution of each method in a test sequence. The presently disclosed methodology accomplishes this by analyzing the component to automatically identify the “Get” methods or properties of the component. These Get methods are then automatically called after the execution of each test method. During the recording process, this state information is saved so that it can be compared during playback. If a state failure occurs during playback the user is notified as to which method caused the failure. That is, in the example given above, a failure would occur as soon as the add ( ) method is called because the internal value would have been obtained and compared as soon as the add ( ) method completed. The user does not have to wait for a future method result to fail in order to signal this particular problem. With this invention, fault diagnosis and isolation is greatly improved.

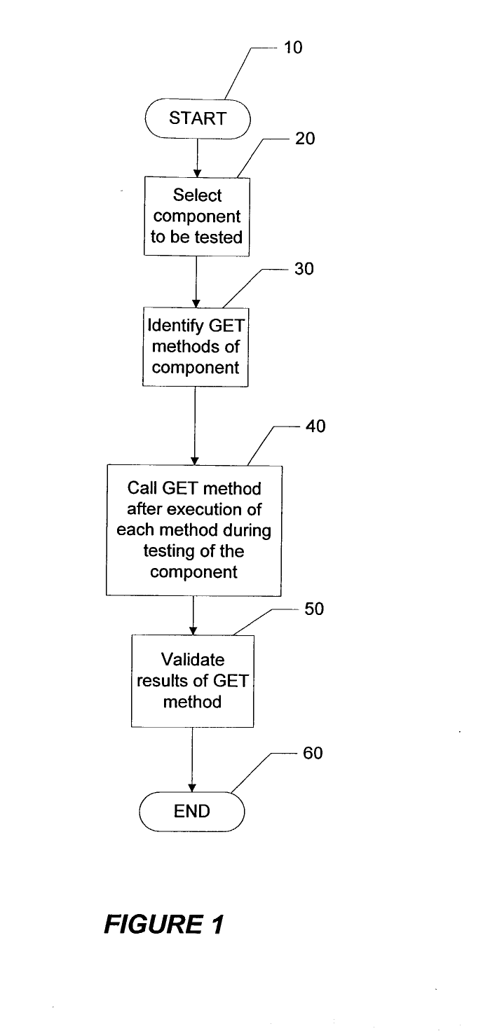

A flow chart of the presently disclosed method is depicted in FIG. 1. The rectangular elements, are herein denoted “processing blocks” and represent computer software instructions or groups of instructions. The diamond shaped elements, are herein denoted “decision blocks,” represent computer software instructions, or groups of instructions which affect the execution of the computer software instructions represented by the processing blocks.

Alternatively, the processing and decision blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 1, the flow chart for the presently disclosed invention is shown. The process begins at step 10. This step is for initialization of any variables, counters and the like. Following step 10, step 20 is then executed.

At step 20 the software component to be tested is determined. Once the component to be tested has been identified step 30 is executed.

Step 30 comprises identifying the GET methods of a component. GET methods are the way of obtaining state information regarding the results of certain methods which have been executed.

Step 40 involves calling the appropriate Get method after execution of every method which is executed during testing of the component. Step 40 returns state information pertaining to the most recently executed method.

Following step 40, step 50 is executed. Step 50 validates the result of the Get method operation. At step 60 the process is finished. Step 60 may include such things as notifying the user when the validate step detects an error.

A further embodiment of the present invention involves manually including the state checks after each method call. The preferred embodiment has the advantage over this alternative in that it is automatic and it does not clutter the normal sequence of method calls with all of the calls required to capture the state information. The present invention makes the necessary calls to gather the state information without explicitly listing all of the calls at each point in the test sequence.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A process for tracking methods of a software component comprising:
analyzing a component to be tested;
identifying any Get methods of the component; and
calling said Get methods after execution of each method during testing of the component to obtain state information.

2. The method of claim further comprising validating said state information.

3. The method of claim 1 wherein said component is selected from the group including Enterprise Java Beans™ (EJBs), Component Object Model (COM) components, Distributed Component Object Model (DCOM) components, COM+ components, Common Object Request Broker Architecture (CORBA) components and .net web service components.

4. The method of claim 1 wherein said calling is done automatically.

5. The method of claim 1 wherein said calling is done manually.

6. A computer program product comprising a computer usable medium having computer readable code thereon, including program code comprising:
instructions for analyzing a component to be tested;
instructions for identifying any Get methods of the component; and
instructions for calling said Get methods after execution of each method during testing of the component to obtain state information.

7. The computer program product of claim 6 further comprising instructions for validating said state information.

8. The computer program product of claim 6 wherein said component is selected from the group including Enterprise Java Beans™ (EJBs), Component Object Model (COM) components, Distributed Component Object Model (DCOM) components, COM+ components, Common Object Request Broker Architecture (CORBA) components and .net web service components.

9. The computer program product of claim 6 wherein said calling is done automatically.

10. The computer program product of claim 6 wherein said calling is done manually.
